(19) United States
(12) Patent Application Publication
(10) Pub. No.: US 2023/0320507 A1
(43) Pub. Date: Oct. 12, 2023

(54) Vehicle Portable Coffee Cup

(71) Applicant: Zhejiang Ansheng Technology Co., Ltd., Jinhua (CN)

(72) Inventors: Zhengjian LYU, Jinhua (CN); Haiyang WU, Jinhua (CN); Jianmin LI, Jinhua (CN)

(73) Assignee: Zhejiang Ansheng Technology Co., Ltd., Jinhua (CN)

(21) Appl. No.: 18/111,901

(22) Filed: Feb. 21, 2023

(30) Foreign Application Priority Data
Apr. 7, 2022 (CN) 202210358842.9

(51) Int. Cl. A47G 19/22

(52) U.S. Cl. CPC A47G 19/2272

(57) ABSTRACT

A vehicle portable coffee cup includes a stainless steel cup body, a stainless steel plate, and a plastic ring. A cup lid mechanism is rotated between two articulated blocks by a rotating shaft, and the cup lid mechanism is connected to an L-type slot. An arc hole is arranged on the cup lid mechanism. A filter mechanism is arranged in the stainless steel cup body. A bracket mechanism is arranged on the stainless steel cup body and the plastic ring. A heating mechanism is arranged on the bracket mechanism. A pumping mechanism is arranged on the bracket mechanism. A silicone outlet pipe is arranged on the cup lid mechanism, and one end of the silicone outlet pipe is connected to the pumping mechanism. A control mechanism is arranged on the bracket mechanism. A plug-in hole is arranged on a plastic shell. A battery is arranged on the bracket mechanism.

### CROSS REFERENCE TO THE RELATED APPLICATIONS

This application is based upon and claims priority to Chinese Patent Application No. 202210358842.9, filed on Apr. 7, 2022, the entire contents of which are incorporated herein by reference.

### TECHNICAL FIELD

The invention belongs to the technical field of coffee cup, in particular to a vehicle portable coffee cup.

### BACKGROUND

At present, with the improvement of people's living standard, and in the fast pace of life, people's work pressure increases. Having a cup of coffee in the office or coffee shop can relieve people's fatigue in work and life, as well as relieve their mood. The current society is also an era of developed transportation, and the entry of cars into thousands of households has enlarged people's living radius. Whether it is for business trips, business affairs or leisure vacations, people will always use cars. Cars have become an indispensable partner in people's life, and people cannot drink a cup of hot coffee in the car.

The existing coffee cups need to add hot water to brew coffee. Although the traditional coffee machine can brew coffee, the traditional coffee machine cannot be used in the car, making it impossible to brew coffee through the traditional coffee machine when people are in the car, and there is no hot water stored in the car, making it impossible to brew coffee when people are in the car. Therefore, a vehicle portable coffee cup that can automatically boil water when there is no hot water in the car is required.

### SUMMARY

The purpose of the invention is to provide a vehicle portable coffee cup, which aims to solve the problem that the coffee cup can only be brewed after adding hot water, and can not automatically boil water to pour coffee in the prior art.

To realize the above purpose, the invention provides the following technical scheme:

A vehicle portable coffee cup, including:

Stainless steel cup body;

The stainless steel plate is movable inserted in the lower part of the stainless steel cup body, and the upper end of the stainless steel plate is fixedly connected to a silicone seal;

The plastic ring is arranged on the upper part of the stainless steel cup body, the upper end of the plastic ring is fixedly connected to two articulated blocks, the upper end of the plastic ring is provided with an L-type slot;

The cup lid mechanism is rotated between two articulated blocks by a rotating shaft, and the cup lid mechanism is connected to an L-type slot to seal the upper part of the stainless steel cup body;

Arc hole is arranged on the cup lid mechanism;

The filter mechanism is arranged in the stainless steel cup body, and the filter mechanism is used to place coffee powder;

Bracket mechanism is arranged on the stainless steel cup body and plastic ring;

The heating mechanism is arranged on the bracket mechanism, and the heating mechanism is used to heat the water inside the stainless steel cup body;

The pumping mechanism is arranged on the bracket mechanism, and the pumping mechanism is used to extract the water inside the stainless steel cup body;

The silicone outlet pipe is arranged on the cup lid mechanism, and one end of the silicone outlet pipe is connected to the pumping mechanism;

The control mechanism is arranged on the bracket mechanism;

The plug-in hole is arranged on the plastic shell; and

The battery is arranged on the bracket mechanism.

As an optimal scheme of the invention, the cup lid mechanism comprises a cup lid, a bottom cover plate, a cup mouth sealing ring, a filter sealing ring, a press switch component, a safety lock component and a water retaining cover component. The bottom cover plate is rotated between two articulated blocks through a rotating shaft, the cup lid is clamped on the bottom cover plate, and the cup mouth sealing ring is fixedly connected to the lower end of the bottom cover plate. The filter sealing ring is fixedly connected to the lower end of the bottom cover plate, and the filter sealing ring is arranged on the silicone outlet pipe. The press switch component is arranged on the cup lid and the bottom cover plate, the press switch component is connected to the L-type slot, the safety lock component is arranged on the cup lid, and the safety lock component is connected to the press switch component, so as to limit the position of the press switch component. The water retaining cover component is arranged on the top of the cup lid, and the water retaining cover component is used to seal the arc hole.

As an optimal scheme of the invention, the press switch component comprises an L-type clamp block, a limiting spring, a limiting rod, a press switch, a limiting plate and a positioning baffle. The positioning baffle is provided with two, and the two positioning baffles are fixedly connected to the upper inner wall of the cup lid, and the press switch is movable and inserted into the side inner wall of the cup lid. The press switch moves through the cup lid and extends to the outer side of the cup lid, the limiting rod is provided with two, the two limiting rods are fixedly connected to the press switch on one side of the end, each limiting rod is movable and inserted in each positioning baffle. The limiting spring is arranged with two, each of the limiting spring is arranged on each limiting rod, and each limiting spring is located between each positioning baffle and the press switch. The limiting plate is arranged with two, two of the limiting plate are fixedly connected to the upper wall of the cup lid, and each of the limiting plate is matched with each limiting rod. The L-type clamp block is fixedly connected to the lower end of the press switch, and the L-type clamp block moves through the bottom cover plate and is connected to the L-type slot.

As an optimal scheme of the invention, the safety lock component comprises a push rod, an arc self-locking block, a self-locking socket and an arc plate. The arc plate is fixedly connected to the upper inner wall of the cup lid, the self-locking socket is fixedly connected to the side end of the press switch, and the arc self-locking block is movable and inserted between the arc plate and the side wall of the cup lid. One end of the arc self-locking block is inserted into the side end of the self-locking socket, the push rod is fixedly connected to the side end of the arc self-locking block, and the push rod moves through the cup lid and extends to the outer side of the cup lid.

As an optimal scheme of the invention, the water retaining cover component comprises a water baffle, a self-locking slider, a mounting shaft, a sliding groove, a second limit block, a mounting groove, a first limit block, a limiting groove, a silicone plug, a clamping block and a clamping groove. The mounting groove is arranged on the upper part of the cup lid, and the water baffle is rotated between the side walls of the mounting groove through two mounting shafts. The silicone plug is fixedly connected to the bottom of the water baffle, and the silicone plug is movable and inserted in the arc hole. The clamping groove is arranged on the side of the cup lid, the clamping block is fixedly connected to the side of the water baffle, and the clamping block is movable and connected to the clamping groove. The limiting groove is provided with two, and two of the limiting groove are arranged on the inner wall of the mounting groove. The second limit block is provided with two, and two of the second limit block are fixedly connected to the side of the water baffle. The first limit block is fixedly connected to the inner wall of the mounting groove, the sliding groove is arranged on the side of the water baffle, the self-locking slider is sliding and connected to the sliding groove, and the self-locking slider and the first limit block clamp each other.

As an optimal scheme of the invention, the filter screen mechanism comprises a supporting bucket and a filter screen. The supporting bucket is inserted in the stainless steel cup body, and the supporting bucket is connected to the upper part of the stainless steel cup body. The filter screen is movable and inserted in the supporting bucket, and the filter screen is connected to the supporting bucket.

As an optimal scheme of the invention, the bracket mechanism comprises a plastic shell, a stainless steel shell, a handle, a lower mounting bracket, an upper mounting bracket, a battery transmission sheet, a battery bottom cover and a battery transmission bracket. The plastic shell is movable and inserted at the lower part of the stainless steel cup body, and the stainless steel shell is sheathed at the lower part of the plastic shell. The lower mounting bracket is movable and inserted in the plastic shell, the upper mounting bracket is fixed to the upper part of the lower mounting bracket through a plurality of screws, and the upper mounting bracket and stainless steel plate clamp each other. The battery transmission bracket is fixed to the lower part of the lower mounting bracket, the battery bottom cover is affixed to the lower part of the stainless steel shell, and the battery transmission sheet is fixed to the upper end of the battery bottom cover. One end of the handle is fixedly connected to the plastic shell, and the other end of the handle is fixedly connected to the plastic ring.

As an optimal scheme of the invention, the heating mechanism comprises a heater, a conductor and a first control PCBA board. The first control PCBA board is fixedly connected between the lower mounting bracket and the upper mounting bracket, the heater is fixedly connected to the upper part of the upper mounting bracket, and the heater is electrically connected to the plug-in hole and the first control PCBA board. The heating end of the heater runs through the stainless steel plate and extends to the upper side of the stainless steel plate. The conductor is fixedly connected to the mounting bracket, and the conductor is electrically connected to the first control PCBA board.

As an optimal scheme of the invention, the pumping mechanism comprises a filter piece, a drain pipe, a water pump and a silicone pumping pipe. The drain pipe is fixedly connected to the upper part of the upper mounting bracket, and the filter piece is movable and inserted in the drain pipe. The water pump is fixedly connected to the lower mounting bracket, the input end of the water pump is fixedly connected to the drain pipe, and the water pump is electrically connected to the plug-in hole and the battery. The silicone pumping pipe is arranged in the handle, one end of the silicone pumping pipe is fixedly connected to the output end of the pump, and the other end of the silicone pumping pipe is fixedly connected to the inner wall of the plastic ring.

As an optimal scheme of the invention, the control mechanism comprises a display screen, a key and a second control PCBA board. The second control PCBA board is fixedly connected to the handle, the second control PCBA board is electrically connected to the water pump and the first control PCBA board, and the display screen is installed on the upper part of the handle. The display screen is electrically connected to the second control PCBA board, and the key is installed on the display screen and the second control PCBA board.

Compared with the prior art, the beneficial effects of the invention are:
1. In this scheme, the plug-in hole can be connected to the power supply in the car, the heater can be set to heat the cold water inside the stainless steel cup body, and the hot water can be transported to the filter screen through the water pump, silicone pumping pipe and silicone outlet pipe, so as to wash the coffee powder inside the filter screen, so that the hot coffee can be brewed and drunk in the car.
2. In this scheme, the position of the self-locking socket can be limited and the self-locking socket cannot be moved by inserting the arc self-locking block into the self-locking socket. The movement of the press switch is restricted by the fixed connection between the self-locking socket and the press switch. The cup lid can be prevented from being opened by mistake by inserting the arc self-locking block into the self-locking socket, thus improving the safety.
3. In this scheme, the silicone plug can be set up to block the arc hole, so as to prevent coffee leakage. By moving one end of the self-locking slider to the outside of the sliding groove, the rotation of the water baffle can be limited. The setting of the first limit block can limit the movement of the self-locking slider, prevent the self-locking slider from sliding freely in the sliding groove, and prevent the water baffle from being opened by mistake, so as to improve safety. After the water baffle rotates, it is stuck in the limiting groove through the second limit block, which can fix the rotating position of the water baffle and prevent the rotation of the water baffle when drinking coffee.
4. In this scheme, the water pump can be powered by the battery setting. When hot water is added into the stainless steel cup body, there is no need to connect the plug-in hole with the power supply. The hot water inside the stainless steel cup body can also be transported to the filter screen through the battery power supply to the water pump, so as to rinse the coffee powder in the filter screen.

### BRIEF DESCRIPTION OF THE DRAWINGS

The attached drawings are used to provide a further understanding of the invention and form part of the specification. They are used together with embodiments of the invention to explain the invention and do not constitute a limitation of the invention. In the attached drawings:

FIG. 1 is a three-dimensional structure diagram of the invention;

FIG. 2 is a schematic diagram of the structure of the plug-in hole of the invention;

FIG. 3 is a schematic diagram of the cup lid after rotation;

FIG. 4 is a schematic diagram of the water baffle after rotation of the invention;

FIG. 5 is the explosion diagram at the cup lid and supporting bucket of the invention;

FIG. 6 is the explosion diagram at the water baffle and the self-locking slider of the invention;

FIG. 7 is a structural diagram of the supporting bucket of the invention;

FIG. 8 is an explosion diagram at the filter screen of the invention;

FIG. 9 is a schematic diagram of the silicone pumping pipe of the invention;

FIG. 10 is a partial explosion diagram at the cup lid of the invention;

FIG. 11 is the explosion diagram at the water baffle and the bottom cover plate of the invention;

FIG. 12 is an explosion diagram at the plastic ring and handle of the invention;

FIG. 13 is the explosion diagram of the stainless steel plate and the battery bottom cover of the invention;

FIG. 14 is the explosion diagram at the stainless steel plate and the silicone seal of the invention;

FIG. 15 is a structural diagram of the battery bottom cover and the stainless steel shell of the invention;

FIG. 16 is a schematic diagram of locking of the water baffle of the invention;

FIG. 17 is a schematic diagram of unlocking of the water baffle of the invention.

In the figures: 1. Stainless steel cup body; 2. Plastic shell; 3. Stainless steel shell; 4. Handle; 5. Button; 6. Display screen; 7. Water baffle; 8. Push rod; 9. Cup lid; 10. Plastic ring; 11. Self-locking slider; 12. Plug-in hole; 13. Support bucket; 14. Silicone pumping pipe; 15. Cup mouth sealing ring; 16. Filter seal ring; 17. Silicone outlet pipe; 18. L-type clamp block; 19. L-type slot; 20. Clamping block; 21. Silicone plug; 22. First limit block; 23. Clamping groove; 24. Articulated block; 25. Filter screen; 26. Mounting shaft; 27. limiting groove; 28. Mounting groove; 29. Arc hole; 30. Sliding groove; 31. Rotating shaft; 32. Bottom cover plate; 33. Arc self-locking block; 34. Limiting spring; 35. Limiting rod; 36. Self-locking socket; 37. Limiting plate; 38. Positioning baffle; 39. silicone seal; 40. Heater; 41. Stainless steel plate; 42. Lower mounting bracket; 43. Water pump; 44. Upper mounting bracket; 45. Filter piece; 46. Electrical guide; 47. First control PCBA board; 48. Second control PCBA board; 49. Battery transmission sheet; 50. Battery bottom cover; 51. Battery; 52. Battery transmission bracket; 53. press switch; 54. Second limit block; 55. Arc plate; 56. Drain pipe.

### DETAILED DESCRIPTION OF THE EMBODIMENTS

The following is a clear and complete description of the technical scheme in the embodiment of the invention in combination with the drawings attached to the embodiment of the invention. Obviously, the described embodiment is only a part of the embodiment of the invention, but not the whole embodiment. Based on the embodiments of the invention, all other embodiments obtained by ordinary technicians in the field without creative labor fall within the scope of protection of the invention.

In the description of the invention, it should be noted that the orientation or position relationships indicated by the terms “up”, “down”, “inside”, “outside”, “top/bottom”, etc. are based on the orientation or position relationships shown in the attached drawings only for the purpose of facilitating the description of the invention and simplifying the description. Rather than indicating or implying that the device or element referred to must have a particular orientation, be constructed and operated in a particular orientation and therefore cannot be construed as a limitation of the present invention. Furthermore, the terms “first” and “second” are used for descriptive purposes only and cannot be understood to indicate or imply relative importance.

In the description of the invention, it shall be noted that, unless otherwise expressly specified and qualified, the terms “mounting”, “set”, “socket”, “connection”, etc. shall be understood broadly, such as “connection”, which may be fixed connection, removable connection, or integrated connection; It can be mechanical connection, and can also be electrical connection; It can be directly connected, it can be indirectly connected through an intermediary, and it can be connected to in two components. For ordinary technicians in the field, the specific meaning of the above terms in the present invention can be understood on a case-by-case basis.

### Embodiment 1

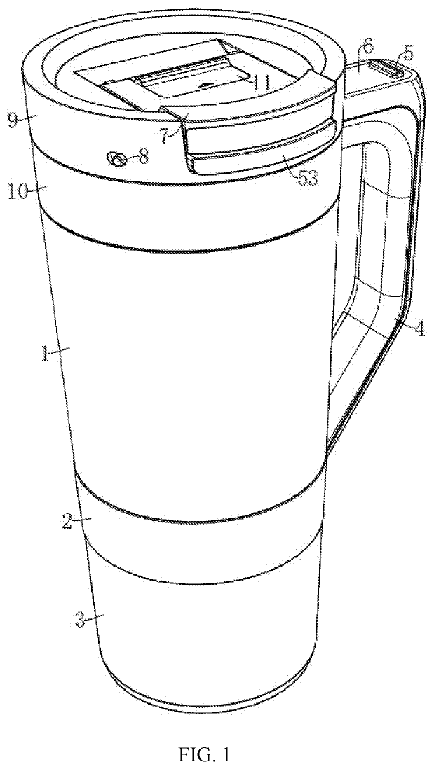

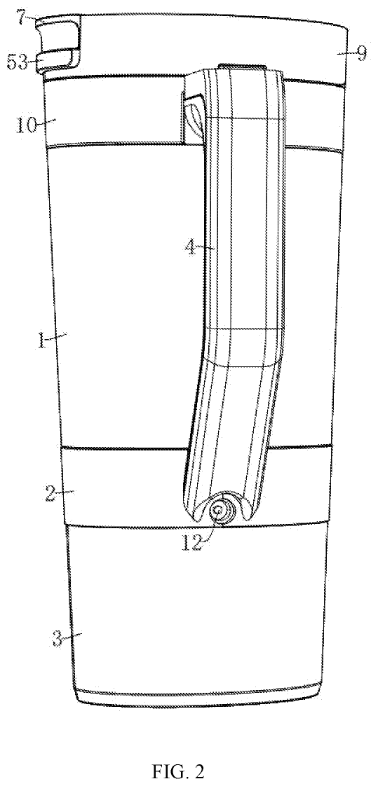

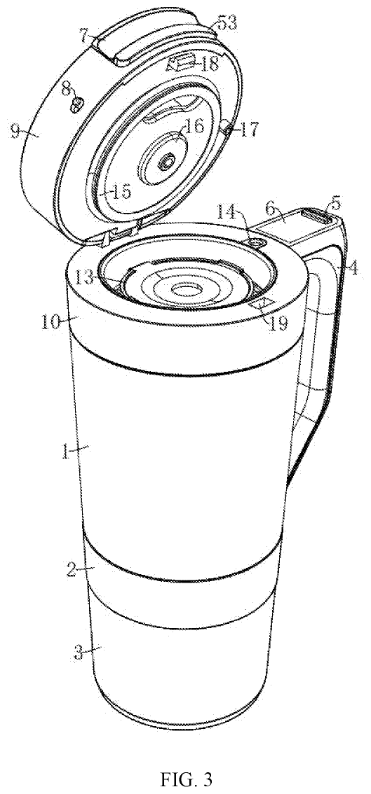

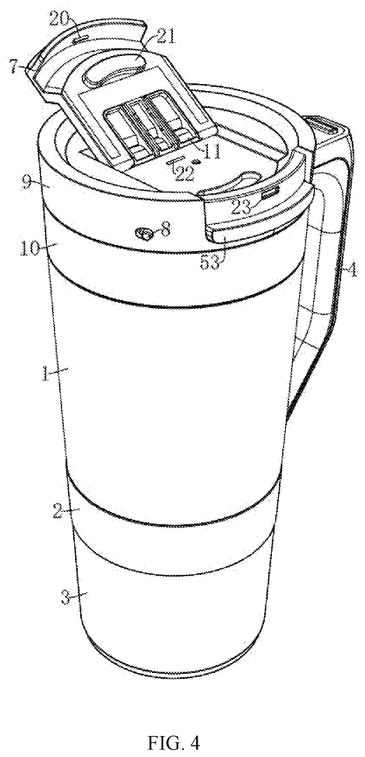

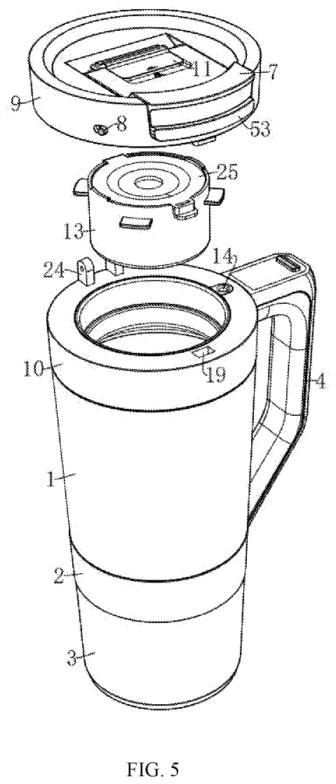

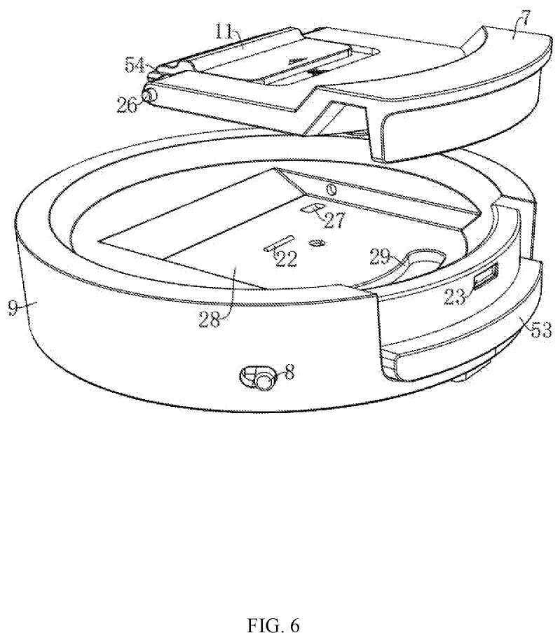

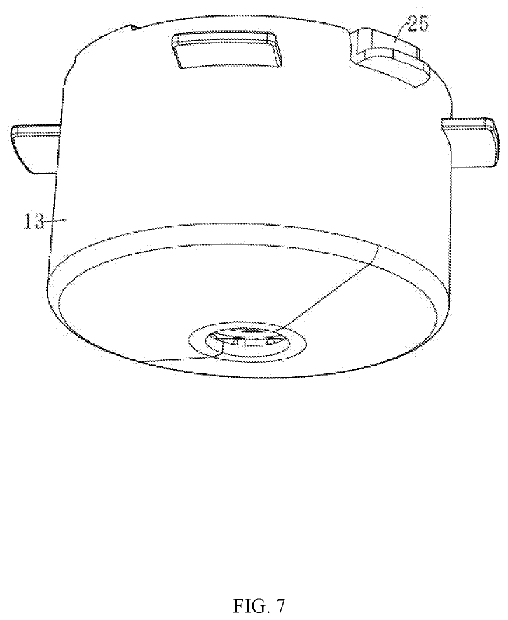

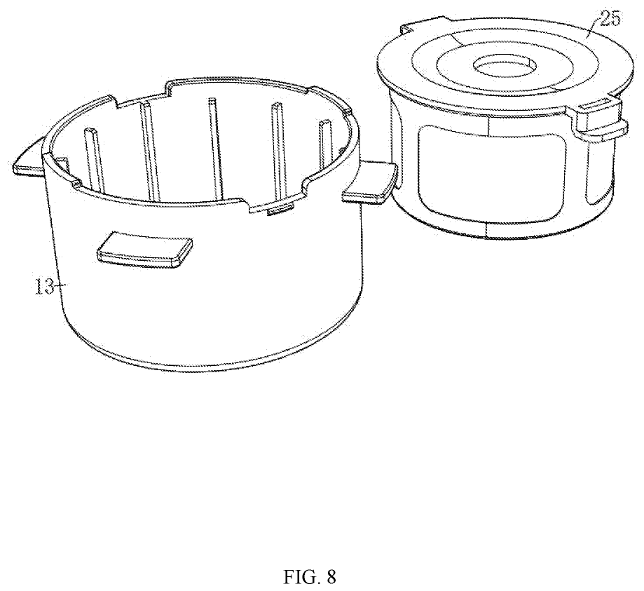

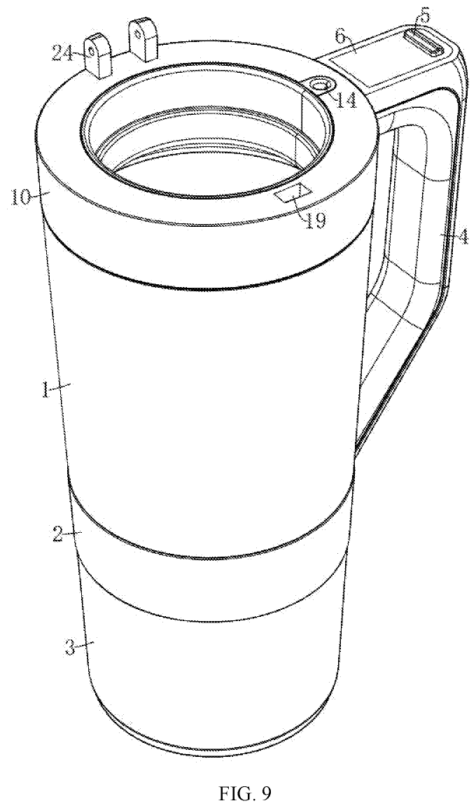

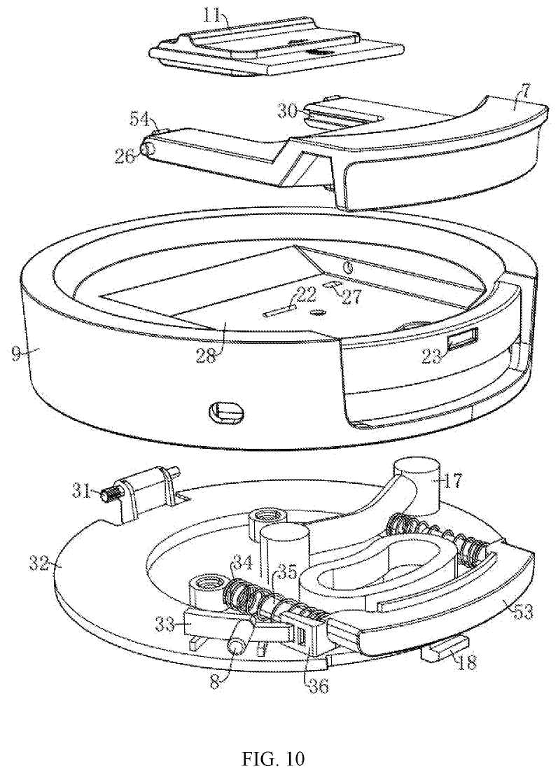

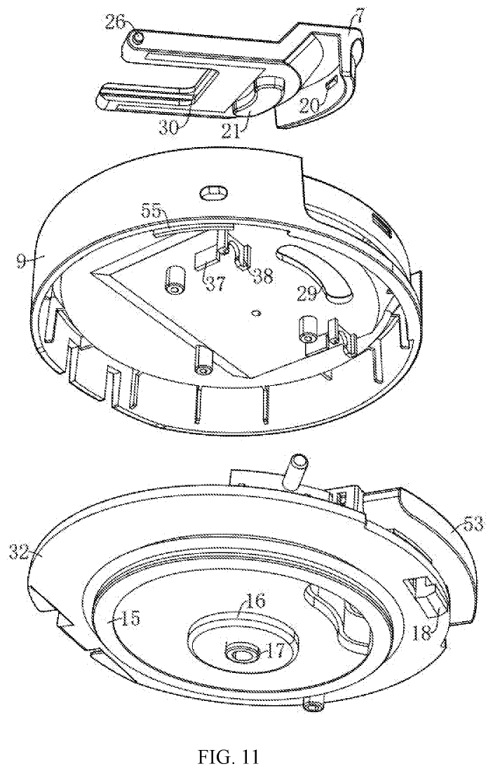

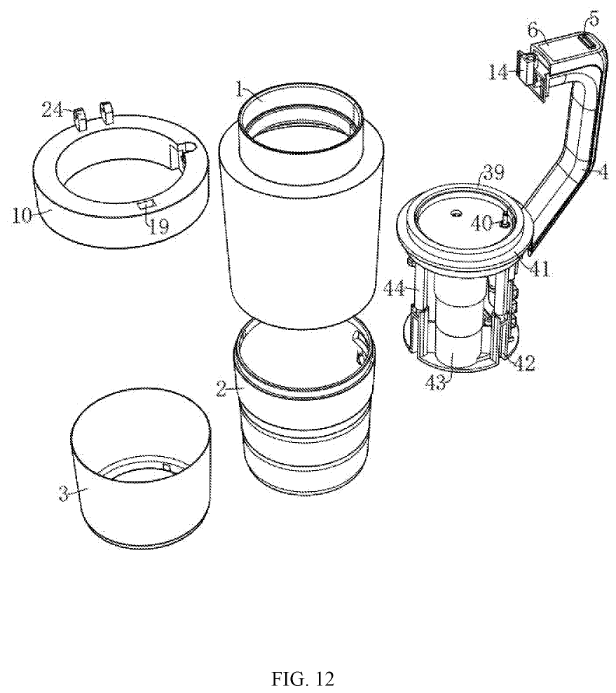

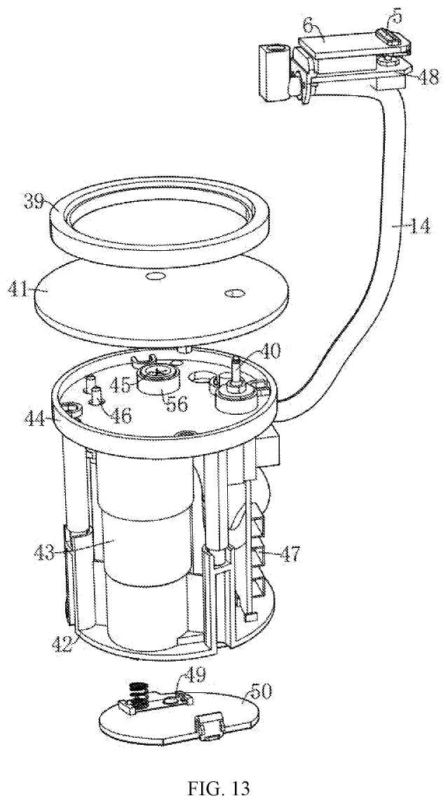

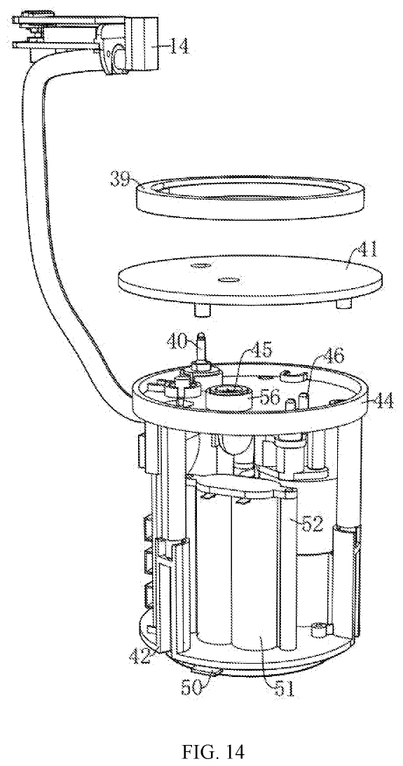

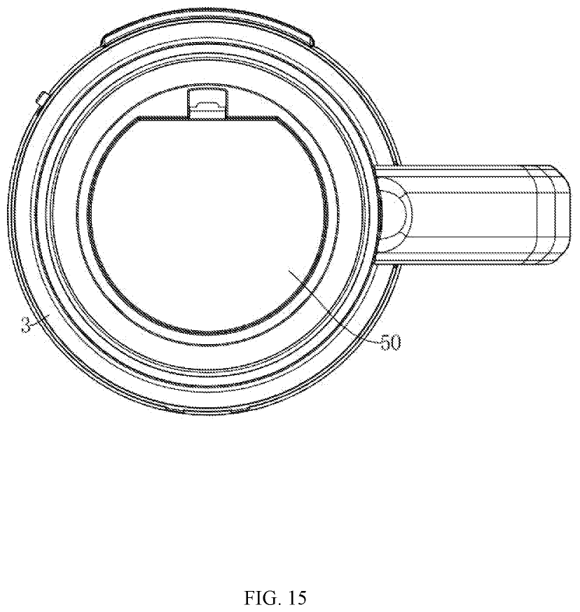

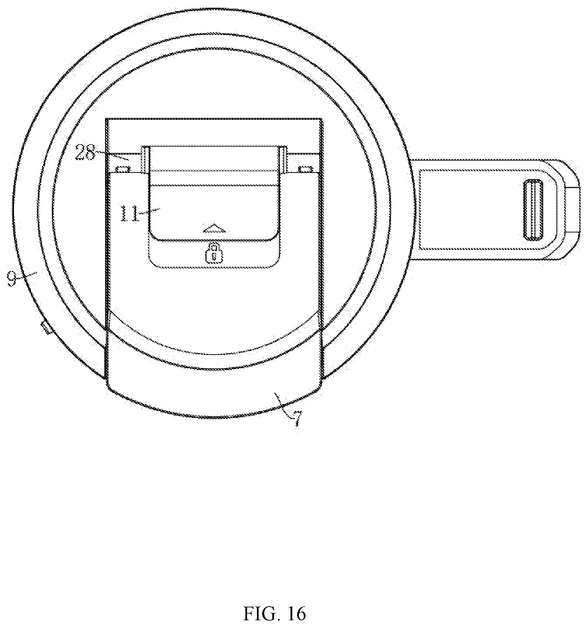

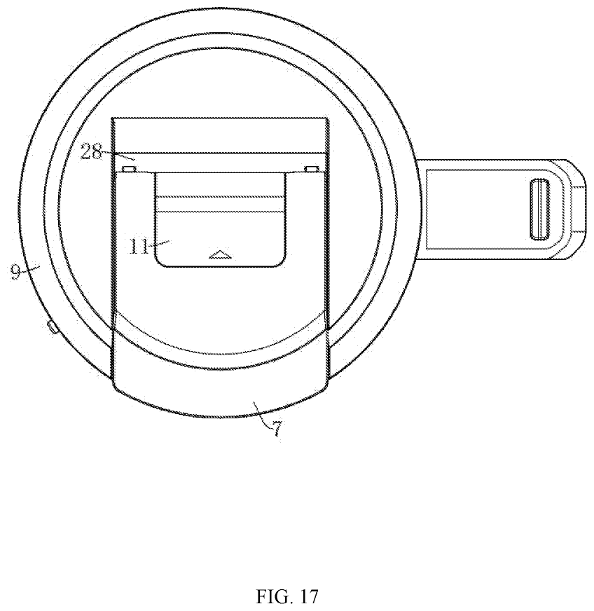

Please refer to FIGS. 1-17. The technical solution provided in this embodiment is as follows:

A vehicle portable coffee cup, including:
Stainless steel cup body 1;
The stainless steel plate 41 is movable inserted in the lower part of the stainless steel cup body 1, and the upper end of the stainless steel plate 41 is fixedly connected to a silicone seal 39;
The plastic ring 10 is arranged on the upper part of the stainless steel cup body 1, the upper end of the plastic ring is fixedly connected to two articulated blocks 24, the upper end of the plastic ring 10 is provided with an L-type slot 19;
The cup lid mechanism is rotated between two articulated blocks 24 by a rotating shaft 31, and the cup lid mechanism is connected to an L-type slot 19 to seal the upper part of the stainless steel cup body 1;
Arc hole 29 is arranged on the cup lid mechanism;
The filter mechanism is arranged in the stainless steel cup body 1, and the filter mechanism is used to place coffee powder;
Bracket mechanism is arranged on the stainless steel cup body 1 and plastic ring 10;
The heating mechanism is arranged on the bracket mechanism, and the heating mechanism is used to heat the water inside the stainless steel cup body 1;
The pumping mechanism is arranged on the bracket mechanism, and the pumping mechanism is used to extract the water inside the stainless steel cup body 1;
The silicone outlet pipe 17 is arranged on the cup lid mechanism, and one end of the silicone outlet pipe 17 is connected to the pumping mechanism;
The control mechanism is arranged on the bracket mechanism;
The plug-in hole 12 is arranged on the plastic shell 2; and
The battery 51 is arranged on the bracket mechanism.

In the specific embodiment of the invention, the bottom of the stainless steel cup body 1 can be covered by the stainless steel plate 41 movable inserted at the bottom of the stainless steel cup body 1, and the sealing effect can be increased by the setting of the silicone seal 39 to prevent the gap between the stainless steel cup body 1 and stainless steel plate 41 from leaking. The stainless steel plate 41 is provided with a through hole. The through hole is aligned with drain pipe 56, the plastic ring 10 is used to connect the handle 4, and the two articulated blocks 24 are used to rotate the connecting bottom cover 32. Arc hole 29 is opened on the upper part of the cup lid 9, and the silicone outlet pipe 17 is fixed connected to the upper part of the bottom cover plate 32, and both ends of the silicone outlet pipe 17 run through the bottom cover plate 32 and extend to the lower side of the bottom cover plate 32. One end of the silicone outlet pipe 17 is movable and inserted into the outlet of the silicone pumping pipe 14. And the other end of the silicone outlet pipe 17 is movable inserted into the water inlet of the filter screen 25, the battery 51 is movable and inserted between the battery transmission bracket 52 and the battery transmission sheet 49, and the plug-in hole 12 is fixed connected to the plastic shell 2.

Specifically, the cup lid mechanism comprises a cup lid 9, a bottom cover plate 32, a cup mouth sealing ring 15, a filter sealing ring 16, a press switch component, a safety lock component and a water retaining cover component. The bottom cover plate 32 is rotated between two articulated blocks 24 through a rotating shaft 31, the cup lid 9 is clamped on the bottom cover plate 32, and the cup mouth sealing ring 15 is fixedly connected to the lower end of the bottom cover plate 32. The filter sealing ring 16 is fixedly connected to the lower end of the bottom cover plate 32, and the filter sealing ring 16 is arranged on the silicone outlet pipe 17. The press switch component is arranged on the cup lid 9 and the bottom cover plate 32, the press switch component is connected to the L-type slot 19, the safety lock component is arranged on the cup lid 9, and the safety lock component is connected to the press switch component, so as to limit the position of the press switch component. The water retaining cover component is arranged on the top of the cup lid 9, and the water retaining cover component is used to seal the arc hole 29.

In the specific embodiment of the invention, the cup lid 9 is used to connect the water baffle 7. The cup mouth of the stainless steel cup body 1 can be covered by the setting of the bottom cover plate 32, and the sealing property of the gap between the bottom cover plate 32 and the stainless steel cup body 1 can be improved by the setting of the cup seal ring 15. The filter sealing ring 16 of the filter screen can improve the sealing property of the connection between the silicone outlet pipe 17 and the filter screen 25.

Specifically, the press switch component comprises an L-type clamp block 18, a limiting spring 34, a limiting rod 35, a press switch 53, a limiting plate 37 and a positioning baffle 38. The positioning baffle 38 is provided with two, and the two positioning baffles 38 are fixedly connected to the upper inner wall of the cup lid 9, and the press switch 53 is movable and inserted into the side inner wall of the cup lid 9. The press switch 53 moves through the cup lid 9 and extends to the outer side of the cup lid 9, the limiting rod 35 is provided with two, the two limiting rods are fixedly connected to the press switch on one side of the end, each limiting rod 35 is movable and inserted in each positioning baffle 38. The limiting spring 34 is arranged with two, each of the limiting spring 34 is arranged on each limiting rod 35, and each limiting spring 34 is located between each positioning baffle 38 and the press switch 53. The limiting plate 37 is arranged with two, two of the limiting plate 37 are fixedly connected to the upper wall of the cup lid 9, and each of the limiting plate 37 is matched with each limiting rod 35. The L-type clamp block 18 is fixedly connected to the lower end of the press switch 53, and the L-type clamp block 18 moves through the bottom cover plate 32 and is connected to the L-type slot 19.

In the specific embodiment of the invention, the position of the bottom cover plate 32 can be limited by connecting the L-type clamp block 18 to the L-type slot 19, the limiting spring 34 can be limited by setting the positioning baffle 38, the limiting rod 35 can move in a directional way by setting the positioning baffle 38, so that the press switch 53 can move more stably. The moving distance of the limiting rod 35 can be limited by the setting of the limiting plate 37. By press switch 53 and the L-type clamp block 18, the L-type clamp block 18 can be driven to move by press switch 53. After moving, the L-type clamp block 18 is engaged and separated from the L-type slot 19.

Specifically, the safety lock component comprises a push rod 8, an arc self-locking block 33, a self-locking socket 36 and an arc plate 55. The arc plate 55 is fixedly connected to the upper inner wall of the cup lid 9, the self-locking socket 36 is fixedly connected to the side end of the press switch 53, and the arc self-locking block 33 is movable and inserted between the arc plate 55 and the side wall of the cup lid 9. One end of the arc self-locking block 33 is inserted into the side end of the self-locking socket 36, the push rod 8 is fixedly connected to the side end of the arc self-locking block 33, and the push rod 8 moves through the cup lid 9 and extends to the outer side of the cup lid 9.

In the specific embodiment of the invention, the position of arc self-locking block 33 can be restricted by the setting of arc plate 55, so that arc self-locking block 33 can only move between arc plate 55 and the inner wall of the cup lid 9, and the movement of self-locking socket 36 can be restricted by the movement of arc self-locking block 33 into the self-locking socket 36. The self-locking socket 36 is fixedly connected to the press switch 53 to limit the movement of the press switch 53. The push rod 8 is fixedly connected to the arc self-locking block 33 to drive the arc self-locking block 33 to move.

Specifically, the water retaining cover component comprises a water baffle 7, a self-locking slider 11, a mounting shaft 26, a sliding groove 30, a second limit block 54, a mounting groove 28, a first limit block 22, a limiting groove 27, a silicone plug 21, a clamping block 20 and a clamping groove 23. The mounting groove 28 is arranged on the upper part of the cup lid 9, and the water baffle 7 is rotated between the side walls of the mounting groove 28 through two mounting shafts 26. The silicone plug 21 is fixedly connected to the bottom of the water baffle 7, and the silicone plug 21 is movable and inserted in the arc hole 29. The clamping groove 23 is arranged on the side of the cup lid 9, the clamping block 20 is fixedly connected to the side of the water baffle 7, and the clamping block 20 is movable and connected to the clamping groove 23. The limiting groove 27 is provided with two, and two of the limiting groove 27 are arranged on the inner wall of the mounting groove 28. The second limit block 54 is provided with two, and two of the second limit block 54 are fixedly connected to the side of the water baffle 7. The first limit block 22 is fixedly connected to the inner wall of the mounting groove 28, the sliding groove 30 is arranged on the side of the water baffle 7, the self-locking slider 11 is sliding and connected to the sliding groove 30, and the self-locking slider 11 and the first limit block 22 clamp each other.

In the specific embodiment of the invention, the mounting groove 28 is used to connect the water baffle 7, and the water baffle 7 can rotate through two mounting shaft 26. The silicone plug 21 is movable and inserted into the arc hole 29, the arc hole 29 can be blocked, and the water baffle 7 can be prevented from rotating by clamping block 20 into the clamping groove 23. When one end of the self-locking slider 11 slides to the outside of the slide 30, the rotation of the water baffle 7 can be restricted. The movement of the self-locking slider 11 can be restricted through the combination of the first limit block 22 and the slot on the self-locking slider 11. After the rotation of the water baffle 7, the second limit block 54 is connected to the limiting groove 27. It can fix the position of the water baffle 7 to prevent the water baffle 7 from turning over when drinking.

Specifically, the filter screen mechanism comprises a supporting bucket 13 and a filter screen 25. The supporting bucket 13 is inserted in the stainless steel cup body 1, and the supporting bucket 13 is connected to the upper part of the stainless steel cup body 1. The filter screen 25 is movable and inserted in the supporting bucket 13, and the filter screen 25 is connected to the supporting bucket 13.

In the specific embodiment of the invention, the supporting bucket 13 is used to install the filter screen 25. The supporting bucket 13 can be placed on the upper part of the stainless steel cup body 1 by the special shape setting of the supporting bucket 13, and the coffee powder can be placed by the setting of the filter screen 25.

Specifically, the bracket mechanism comprises a plastic shell 2, a stainless steel shell 3, a handle 4, a lower mounting bracket 42, an upper mounting bracket 44, a battery transmission sheet 49, a battery bottom cover 50 and a battery transmission bracket 5. The plastic shell 2 is movable and inserted at the lower part of the stainless steel cup body 1, and the stainless steel shell 3 is sheathed at the lower part of the plastic shell 2. The lower mounting bracket 42 is movable and inserted in the plastic shell 2, the upper mounting bracket 44 is fixed to the upper part of the lower mounting bracket 42 through a plurality of screws, and the upper mounting bracket 44 and stainless steel plate 41 clamp each other. The battery transmission bracket 52 is fixed to the lower part of the lower mounting bracket 42, the battery bottom cover 50 is affixed to the lower part of the stainless steel shell 3, and the battery transmission sheet 49 is fixed to the upper end of the battery bottom cover 50. One end of the handle 4 is fixedly connected to the plastic shell 2, and the other end of the handle 4 is fixedly connected to the plastic ring 10.

In the specific embodiment of the invention, the protective effect can be achieved by the setting of the plastic shell 2 and the stainless steel shell 3. The lower mounting bracket 42 and the upper mounting bracket 44 are used to connect the water pump 43, the first control PCBA board 47, the conduction device 46 and the heater 40. The battery transmission plate 49 and the battery transmission support 52 are used to connect the battery 51. The battery bottom cover 50 is used to connect the battery transmission sheet 49, which is clamped to the lower part of the stainless steel housing 3 through the battery bottom cover 50, so that the battery bottom cover 50 and the battery transmission sheet 49 are easy to remove and install.

Specifically, the heating mechanism comprises a heater 40, a conductor 46 and a first control PCBA board 47. The first control PCBA board 47 is fixedly connected between the lower mounting bracket 42 and the upper mounting bracket 44, the heater 40 is fixedly connected to the upper part of the upper mounting bracket 44, and the heater 40 is electrically connected to the plug-in hole 12 and the first control PCBA board 47. The heating end of the heater 40 runs through the stainless steel plate 41 and extends to the upper side of the stainless steel plate 41. The conductor 46 is fixedly connected to the mounting bracket 44, and the conductor 46 is electrically connected to the first control PCBA board 47.

In the specific embodiment of the invention, the heater 40 and the conductor 46 can be controlled by the setting of the first control PCBA board 47, and the water inside the stainless steel cup body 1 can be heated by the setting of the heater 40. The internal structure of the conductor 46 and the conductor 40 is the common knowledge of the technical personnel in the field, so it will not be repeated here.

Specifically, the pumping mechanism comprises a filter piece 45, a drain pipe 56, a water pump 43 and a silicone pumping pipe 14. The drain pipe 56 is fixedly connected to the upper part of the upper mounting bracket 44, and the filter piece 45 is movable and inserted in the drain pipe 56. The water pump 43 is fixedly connected to the lower mounting bracket 42, the input end of the water pump 43 is fixedly connected to the drain pipe 56, and the water pump 43 is electrically connected to the plug-in hole 12 and the battery 51. The silicone pumping pipe 14 is arranged in the handle 4, one end of the silicone pumping pipe 14 is fixedly connected to the output end of the pump 43, and the other end of the silicone pumping pipe 14 is fixedly connected to the inner wall of the plastic ring 10.

In the specific embodiment of the invention, water can be transmitted through the setting of drain pipe 56, so that the input end of pump 43 is connected to the interior of stainless steel cup body 1, and the impurities in the water can be filtered through the setting of filter plate 45. The silicone pumping pipe 14 is used to connect pump 43 and the silicone outlet pipe 17. The water inside the stainless steel cup body 1 can be transported to the silicone outlet pipe 17 through the setting of water pump 43.

Specifically, the control mechanism comprises a display screen 6, a key 5 and a second control PCBA board 48. The second control PCBA board 48 is fixedly connected to the handle 4, the second control PCBA board 48 is electrically connected to the water pump 43 and the first control PCBA board 47, and the display screen 6 is installed on the upper part of the handle 4. The display screen 6 is electrically connected to the second control PCBA board 48, and the key 5 is installed on the display screen 6 and the second control PCBA board 48.

In the specific embodiment of the invention, the heating temperature can be displayed by setting the display screen 6, and the water pump 43 and the heater 40 can be controlled by setting the key 5 and the second control PCBA board 48.

The working principle or working process of a vehicle portable coffee cup provided by the invention is as follows: firstly, the push rod 8 is moved to drive the arc self-locking block 33 to move, so that the arc self-locking block 33 is clamped and separated from the self-locking socket 36; after the arc self-locking block 33 is clamped and separated from the self-locking socket 36, the press switch 53 is pushed; the press switch 53 moves and compresses the two limit springs 34. At the same time, press switch 53 moves the two limit rods 35 and L-type clamp block 18. When the limit plate 37 restricts the movement of the limit rod 35, the press switch 53 cannot be pushed, and the press switch 53 cannot push the rear L-type clamp block 18 to snap and separate from the L-type slot 19, so as to rotate the bottom cover plate 32 and the cup lid 9. After the bottom cover plate 32 and the cup lid 9 rotate, the support bucket 13 and the filter screen 25 are taken out of the stainless steel cup body 1, the cold water is added to the stainless steel cup body 1, the coffee powder is added to the filter screen 25, and the support bucket 13 and the filter screen 25 are placed in the stainless steel cup body 1. Push the press switch 53, rotate the cup lid 9 and the bottom cover plate 32, and then the L-type clamp block 18 is clamped into the L-type slot 19. Move the push rod 8 to make the arc self-locking block 33 and the self-locking socket 36 engage with each other. Connect the power supply to the plug-in hole 12, press the button 5, and start the heater 40. After the heater 40 starts, the cold water inside the stainless steel cup body 1 will be heated to 100° C. When the cold water inside the stainless steel cup body 1 is heated to 100° C., the water pump 43 will be started. Pump 43 will pump the extracted water through the silicone pumping pipe 14 to the silicone outlet pipe 17. The hot water is transported to the filter screen 25 through the silicone outlet pipe 17, and the coffee powder is washed after the hot water enters the filter screen 25. The water baffle 7 is rotated to make the silicone plug 21 move out from the arc hole 29, and the second limit block 54 card is connected to the limiting groove 27 after the rotation of the water baffle 7, so as to fix the position of the water baffle 7, so that the arc hole 29 is exposed.

Finally, it should be noted that the above are only preferred embodiments of the invention and are not used to limit the invention. Although the invention is described in detail by referring to the aforementioned embodiments, for the technical personnel in the field, the technical scheme recorded in the aforementioned embodiments can still be modified or some of the technical features can be replaced equally. Any modification, equivalent replacement, improvement, etc. made within the spirit and principles of the invention shall be included in the scope of protection of the invention.

What is claimed is:

1. A vehicle portable coffee cup, comprising:
a stainless steel cup body;
wherein a stainless steel plate is movable inserted in a lower part of the stainless steel cup body, and an upper end of the stainless steel plate is fixedly connected to a silicone seal;
a plastic ring is arranged on an upper part of the stainless steel cup body, an upper end of the plastic ring is fixedly connected to two articulated blocks, and the upper end of the plastic ring is provided with an L-type slot;
a cup lid mechanism is rotated between the two articulated blocks by a rotating shaft, and the cup lid mechanism is connected to an L-type slot to seal the upper part of the stainless steel cup body;
an arc hole is arranged on the cup lid mechanism;
a filter mechanism is arranged in the stainless steel cup body, and the filter mechanism is used to place coffee powder;
a bracket mechanism is arranged on the stainless steel cup body and the plastic ring;
a heating mechanism is arranged on the bracket mechanism, and the heating mechanism is used to heat water inside the stainless steel cup body;
a pumping mechanism is arranged on the bracket mechanism, and the pumping mechanism is used to extract the water inside the stainless steel cup body;
a silicone outlet pipe is arranged on the cup lid mechanism, and one end of the silicone outlet pipe is connected to the pumping mechanism;
a control mechanism is arranged on the bracket mechanism;
a plug-in hole is arranged on a plastic shell; and
a battery is arranged on the bracket mechanism.

2. The vehicle portable coffee cup according to claim 1, wherein the cup lid mechanism comprises a cup lid, a bottom cover plate, a cup mouth sealing ring, a filter sealing ring, a press switch component, a safety lock component and a water retaining cover component; wherein the bottom cover plate is rotated between the two articulated blocks through the rotating shaft, the cup lid is clamped on the bottom cover plate, and the cup mouth sealing ring is fixedly connected to a lower end of the bottom cover plate; the filter sealing ring is fixedly connected to the lower end of the bottom cover plate, and the filter sealing ring is arranged on the silicone outlet pipe; the press switch component is arranged on the cup lid and the bottom cover plate, the press switch component is connected to the L-type slot, the safety lock component is arranged on the cup lid, and the safety lock component is connected to the press switch component to limit a position of the press switch component; the water retaining cover component is arranged on a top of the cup lid, and the water retaining cover component is used to seal the arc hole.

3. The vehicle portable coffee cup according to claim 2, wherein the press switch component comprises an L-type clamp block, two limiting springs, two limiting rods, a press switch, two limiting plates and two positioning baffles; wherein the two positioning baffles are fixedly connected to an upper inner wall of the cup lid, and the press switch is movable and inserted into a side inner wall of the cup lid; the press switch moves through the cup lid and extends to an outer side of the cup lid, the two limiting rods are fixedly connected to a side end of the press switch, each of the two limiting rods is movable and inserted in each of the two positioning baffles; each of the two limiting springs is arranged on each of the two limiting rods, and each of the two limiting springs is located between each of the two positioning baffles and the press switch; the two limiting plates are fixedly connected to an upper wall of the cup lid, and each of the two limiting plates is matched with each of the two limiting rods; the L-type clamp block is fixedly connected to a lower end of the press switch, and the L-type clamp block moves through the bottom cover plate and is connected to the L-type slot.

4. The vehicle portable coffee cup according to claim 3, wherein the safety lock component comprises a push rod, an arc self-locking block, a self-locking socket and an arc plate; wherein the arc plate is fixedly connected to the upper inner wall of the cup lid, the self-locking socket is fixedly connected to the side end of the press switch, and the arc self-locking block is movable and inserted between the arc plate and a side wall of the cup lid; one end of the arc self-locking block is inserted into a side end of the self-locking socket, the push rod is fixedly connected to a side end of the arc self-locking block, and the push rod moves through the cup lid and extends to the outer side of the cup lid.

5. The vehicle portable coffee cup according to claim 4, wherein the water retaining cover component comprises a water baffle, a self-locking slider, a mounting shaft, a sliding groove, two second limit blocks, a mounting groove, a first limit block, two limiting grooves, a silicone plug, a clamping block and a clamping groove; wherein the mounting groove is arranged on an upper part of the cup lid, and the water baffle is rotated between side walls of the mounting groove through two mounting shafts; the silicone plug is fixedly connected to a bottom of the water baffle, and the silicone plug is movable and inserted in the arc hole; the clamping groove is arranged on a side of the cup lid, the clamping block is fixedly connected to a side of the water baffle, and the clamping block is movable and connected to the clamping groove; the two limiting grooves are arranged on an inner wall of the mounting groove; the two second limit blocks are fixedly connected to the side of the water baffle; the first limit block is fixedly connected to the inner wall of the mounting groove, the sliding groove is arranged on the side of the water baffle, the self-locking slider is sliding and connected to the sliding groove, and the self-locking slider and the first limit block clamp each other.

6. The vehicle portable coffee cup according to claim 5, wherein the filter screen mechanism comprises a supporting bucket and a filter screen; wherein the supporting bucket is inserted in the stainless steel cup body, and the supporting bucket is connected to the upper part of the stainless steel cup body; the filter screen is movable and inserted in the supporting bucket, and the filter screen is connected to the supporting bucket.

7. The vehicle portable coffee cup according to claim 6, wherein the bracket mechanism comprises a plastic shell, a stainless steel shell, a handle, a lower mounting bracket, an upper mounting bracket, a battery transmission sheet, a battery bottom cover and a battery transmission bracket; wherein the plastic shell is movable and inserted at the lower part of the stainless steel cup body, and the stainless steel shell is sheathed at a lower part of the plastic shell; the lower mounting bracket is movable and inserted in the plastic shell, the upper mounting bracket is fixed to an upper part of the lower mounting bracket through a plurality of screws, and the upper mounting bracket and the stainless steel plate clamp each other; the battery transmission bracket is fixed to a lower part of the lower mounting bracket, the battery bottom cover is affixed to a lower part of the stainless steel shell, and the battery transmission sheet is fixed to an upper end of the battery bottom cover; a first end of the handle is fixedly connected to the plastic shell, and a second end of the handle is fixedly connected to the plastic ring.

8. The vehicle portable coffee cup according to claim 7, wherein the heating mechanism comprises a heater, a conductor and a first control printed circuit board assembly (PCBA) board; wherein the first control PCBA board is fixedly connected between the lower mounting bracket and the upper mounting bracket, the heater is fixedly connected to an upper part of the upper mounting bracket, and the heater is electrically connected to the plug-in hole and the first control PCBA board; a heating end of the heater runs through the stainless steel plate and extends to an upper side of the stainless steel plate; the conductor is fixedly connected to the upper mounting bracket, and the conductor is electrically connected to the first control PCBA board.

9. The vehicle portable coffee cup according to claim 8, wherein the pumping mechanism comprises a filter piece, a drain pipe, a water pump and a silicone pumping pipe; wherein the drain pipe is fixedly connected to the upper part of the upper mounting bracket, and the filter piece is movable and inserted in the drain pipe; the water pump is fixedly connected to the lower mounting bracket, an input end of the water pump is fixedly connected to the drain pipe, and the water pump is electrically connected to the plug-in hole and the battery; the silicone pumping pipe is arranged in the handle, a first end of the silicone pumping pipe is fixedly connected to an output end of the pump, and a second end of the silicone pumping pipe is fixedly connected to an inner wall of the plastic ring.

10. The vehicle portable coffee cup according to claim 9, wherein the control mechanism comprises a display screen, a key and a second control PCBA board; wherein the second control PCBA board is fixedly connected to the handle, the second control PCBA board is electrically connected to the water pump and the first control PCBA board, and the display screen is installed on an upper part of the handle; the display screen is electrically connected to the second control PCBA board, and the key is installed on the display screen and the second control PCBA board.
